(19) United States
(12) Patent Application Publication
(10) Pub. No.: US 2003/0050984 A1
(43) Pub. Date: Mar. 13, 2003

(54) Internet redirection methods

(75) Inventors: Robert Barkley Pickup, Beaumaris (AU); Mark David Yeoman, St Kilda West (AU)

Correspondence Address: OLIFF & BERRIDGE, PLC, P.O. BOX 19928, ALEXANDRIA, VA, 22320, US

(73) Assignee: AUTOMATIC PTY LTD, Melbourne (AU)

(21) Appl. No.: 10/163,374

(22) Filed: Jun. 7, 2002

Related U.S. Application Data
(63) Continuation of application No. PCT/AU00/01509, filed on Dec. 7, 2000.

(30) Foreign Application Priority Data
Dec. 7, 1999 (AU) PQ4493

(51) Int. Cl. G06F 15/16

(52) U.S. Cl. 709/206; 709/245

(57) ABSTRACT

A method of delivering email from a sender to a recipient, via a redirection service, including the step of the sender obtaining the recipient's telephone number. Thereafter, the sender forwards an email message to the email address: <telephone number>@<redirection service domain>. The redirection service receives the message and checks to see whether the recipient's telephone number is registered with the redirection service. If the recipient's telephone number is registered, the redirection service forwards the email message to an address which has previously been specified by the recipient. A similar method applies for directing a computer user to an Internet site associated with a person or business, via a redirection service.

### FIELD OF THE INVENTION

This invention relates to Internet redirection methods. It relates particularly but not exclusively to a method of delivering email from a sender to a recipient, via a redirection service, and to a method of directing a computer user to an Internet site associated with a person or business, via a redirection service.

### BACKGROUND TO THE INVENTION

Electronic mail is a popular and useful way of communicating; however, it is necessary to know the email address of a prospective recipient before a message can be sent. Most people choose to use their own name as part of their email address, but it is usually difficult or impossible to guess a person's full email address without further information. Some email services such as Hotmail are very popular, and it is often possible to guess that a person has an email address such as <name>@hotmail.com; however, there are millions of subscribers to the Hotmail service, so that there are typically numerous subscribers having the same name, and they must all choose different email addresses. There are numerous directories of email addresses available, but many people choose not to have their email addresses listed in public directories in order to reduce problems associated with junk email (spam).

Similarly, Internet web sites have become very popular as a means of locating information about a business or person, but there can be problems associated with locating a particular web site. It is often possible to guess the address for the web site of a business using www.<business name>.<ext>, where the item <business name> consists of the whole or part of, or an abbreviation of, the name of the relevant business, and the item <ext> consists of “com.au” if the business is located in Australia, “co.nz” if it is located in New Zealand, “corn” if it is located in USA, etc. However, the address must be an exact match before a web site will be located, and it is often difficult to guess the correct address.

Internet search engines often provide assistance in locating the web site for a business. However, there is no guarantee that the business of interest will be registered with a particular search engine, and even if it is registered, a search may not locate it because of the vast number of web sites on the Internet, and the number of businesses with similar names.

There is therefore a need for more efficient ways of sending email to a person when the person's email address is not known and of locating the Internet web site of a business or person.

### SUMMARY OF THE INVENTION

According to a first aspect of the invention, there is provided a method of delivering email from a sender to a recipient, via a redirection service, including the following steps:

(a) the sender obtains the recipient's telephone number;

(b) the sender forwards an email message to the email address:

<telephone number>@<redirection service domain>

(c) the redirection service receives the message and checks to see whether the recipient's telephone number is registered with the redirection service;

(d) if the recipient's telephone number is registered, the redirection service forwards the email message to an address which has previously been specified by the recipient.

The sender may obtain the recipient's telephone number in any suitable manner. Most people who have telephones are listed in a directory, and it is therefore usually easier to locate a person's telephone number than to locate his or her email address. Further, many telephones now allow the user to store the number of a person who has called. Accordingly, the phone user can accumulate the telephone numbers of all people who call.

All that the sender needs in order to send an email message to the recipient is the recipient's telephone number and the details of the redirection service domain. The message is then sent using a standard email program to an address in the format 123456789@service.com, where “123456789” is replaced by the recipient's telephone number and “service.com” is replaced by the domain of the redirection service.

The redirection service maintains a database which lists the telephone numbers of people who have registered to receive emails, together with their email addresses. Email forwarding is done by a look-up process.

If the recipient's telephone number is not registered, the redirection service may forward to the recipient a notification that email is waiting for the recipient. The recipient may than access the redirection service's web site and register an email address in order to receive future email. If the recipient does not already have an email address, the redirection service may offer the user an email account provided by the redirection service provider or alternatively refer the recipient to an email service provider.

It is especially preferred, where the telephone number is not registered with the redirection service, that the telephone number be a mobile telephone number. If the number is not a mobile telephone number, the redirection service could perform a number-to-address lookup on the number, and then send a notification by post to the owner; alternatively, a voice message could be transmitted to the telephone number; although both of these methods involve expense, and neither is fail-safe. However, in the preferred case of a mobile telephone number, the notification forwarded to unregistered recipients may be in the form of an SMS (short message service) message. SMS messages are like pager messages, appearing in text form on the LCD display on a GSM mobile telephone. In the case of telephones or networks that do not support SMS functionality, a voice message may be used as the notification vehicle.

There are various different ways in which the redirection service can earn revenue. In a preferred arrangement, the redirection service adds advertising material to redirected email messages, and the redirection service derives revenue from advertisers.

In addition to offering telephone number redirection services, the redirection service may offer aliasing, in which the sender enters an alias for the receiver such as “john@redirectdomain”, rather than entering the receiver's telephone number such as “0123456789@redirectdomain”.

According to a second aspect of the invention, there is provided a method of delivering email from a sender to a recipient, via a redirection service, including the following steps:

(a) the sender has redirection service software integrated into or additional to his or her email software;

(b) the sender obtains the recipient's telephone number;

(c) the sender sends an email message to the email address:

+P2

<telephone number>

using the redirection service software and/or his or her standard email application software;

(d) the redirection service software forwards the recipient's telephone number to the redirection service;

(e) the redirection service receives the telephone number and checks to see whether it is registered with the redirection service;

(f) if the recipient's telephone number is registered, the redirection service forwards the email message to an address which has previously been specified by the recipient.

The redirection service may then notify the sender of the email via the redirection service software, advising them of the status of the forwarded email message.

The email address used by the sender may include an identifier in addition to the recipient's telephone number. The purpose of the identifier is to alert the redirection service software that the email address being entered is a telephone number rather than a normal email address.

As an enhancement to the email redirection service, the redirection service provider may offer a loyalty program, which measures the quantity of email received or sent through the redirection service and provides rewards. One suitable form of rewards is a credit in the form of paid telephony minutes for the user's telephone account. The user's account can be credited on a periodic or loyalty points threshold basis. Alternatively or additionally, the redirection service provider may elect to provide loyalty points as part of a larger loyalty program such as a frequent flyer program.

According to a third aspect of the invention there is provided a method of directing a computer user to an Internet site associated with a person or business, via a redirection service, including the following steps:

(a) the computer user obtains the telephone number of the person or business;

(b) the computer user types into an Internet browser the following:

+P2

<telephone number>@<redirection service domain>

(c) the redirection service checks to see whether the person or business's telephone number is registered with the redirection service;

(d) if the person or business's telephone number is registered, the redirection service redirects the computer user's browser to an address which has previously been specified by the person or business.

If the person or business's telephone number is not registered, the redirection service may forward to the person or business a notification inviting the person or business to register.

If the telephone number is a mobile telephone number, the notification may be forwarded to unregistered persons and businesses in the form of an SMS message.

There are various different ways in which the redirection service can earn revenue from the second aspect of the invention. In a preferred arrangement, unless otherwise arranged by the person or business whose telephone number is registered, the redirection service displays advertising material for a short time before proceeding with the redirection, and the redirection service derives revenue from advertisers. The person or business whose telephone number is registered may elect to pay a fee to the redirection service, whereupon redirection proceeds immediately, with no advertising material being displayed.

In addition to offering telephone number Internet address redirection services, the redirection service may offer aliasing, in which the computer user enters an alias for the person or business such as “john@redirectdomain”, rather than entering the person or business's telephone number such as “0123456789@redirectdomain”.

According to a fourth aspect of the invention, there is provided a method of directing a computer user to an Internet site associated with a person or business, via a redirection service, including the following steps:

(a) the computer user has redirection service software integrated into or additional to his or her web browser software;

(b) the computer user obtains the telephone number of the person or business;

(c) the computer user types into an Internet browser or the redirection service software the following:

<telephone number>

(d) the redirection service software forwards the telephone number to the redirection service;

(e) the redirection service checks to see whether the person or business's telephone number is registered with the redirection service;

(f) if the person or business's telephone number is registered, the redirection service redirects the computer user's browser to an Internet address which has previously been specified by the person or business.

The Internet address which the computer user types into his or her browser may include an identifier in addition to the person or business's telephone number. The purpose of the identifier is to alert the redirection service software that the Internet address being entered is a telephone number rather than a normal Internet address.

### BRIEF DESCRIPTION OF THE DRAWINGS

The invention will now be described in further detail with reference to the attached drawing which shows an example form of the invention. It is to be understood that the particularity of the drawing does not supersede the generality of the preceding description of the invention.

FIG. 1 is a schematic diagram of an embodiment of infrastructure suitable for implementing the invention.

### DETAILED DESCRIPTION

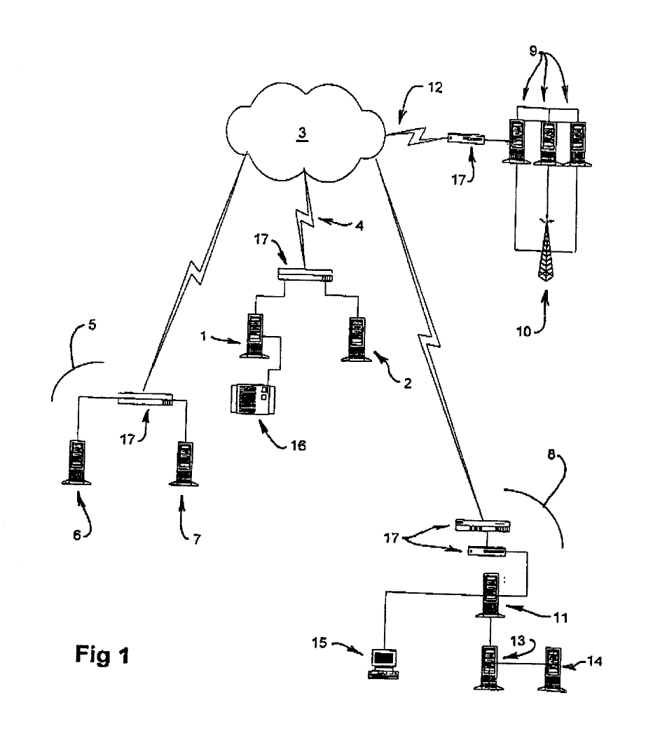

As shown in FIG. 1, the infrastructure comprises a production mail server 1 with database 16, together with a production web server 2. These constitute the principal components of the infrastructure, and they are linked to the Internet 3 through a high bandwidth connection 4.

A subscriber of the redirection service uses the phone number of a person or business in an email format such as 0123456789@redirectdomain and enters it on the website of the redirection service. Production mail server 1 searches database 16 to check if the telephone number is for a person or business which has registered with the service to receive emails. If the number refers to an existing record, mail server 1 generates an email transmission and forwards the text of the original email, entered by the subscriber, to the intended recipient over Internet 3. If the intended recipient's telephone number is not registered in the database, the system preferably contacts the recipient using the number entered by the user and notifies the recipient that a message is waiting for them at the redirection service's website.

A plurality of SMS servers 9 allow the sending of pager-type messages to GSM mobile telephones via a cellular network 10 which may be automatically generated by the redirection service and sent to the recipient's mobile phone to notify them that an email message is waiting for them on the redirection service's website. SMS gateway 12 consists of one or more SMS servers 9 connected via IP to mail server 1. SMS gateway 12 is not physically located near mail server 1; instead, it is in a more accessible location for maintenance purposes. SMS gateway 12 as illustrated, consists of a series of servers 9 connected directly or via cellular network to each mobile telephone network. Mail server 1 sends an SMS message request to SMS gateway 12 via IP, which then identifies the correct cellular network 10 for the particular recipient and delivers the message into the SMS network. Additional SMS networks and higher traffic throughput can quickly be brought online by adding more SMS gateways. The initial method of SMS delivery is via cellular telephone handsets, but provision has been made for delivery via PSTN/X25 dial-up or other direct interface if and when the mobile phone companies enable such a service.

In order to safeguard against failure, a backup system 5 is provided at a different location. Backup system 5 also has a mail server 6 and a web server 7, with a mirrored copy of the database. This enables the redirection service to continue to operate if errors or physical damage occurs at the site of production mail server 1 and production web server 2. In the event of catastrophic failure on the part of the mail server 1, incoming emails are automatically routed to a backup system 5 located at a separate site. The backup server 7 stores and processes any mail until the primary mail server is brought back on line. An option exists to mirror the database associated with server 1 in real time with backup facilities.

Another infrastructure component shown in FIG. 1 is internal administration network 8, which is operated by the redirection service. It includes an office server 11, production network administration 15, development server 13 and staging server 14. This facilitates development of the redirection service to accommodate new technologies and developments in email and message redirection. Internal administration network 8 is protected from the public Internet 3 and hackers from outside the development and administration network by firewall 17.

The web server 2 exists primarily to enable users to supply and edit their registration and account details. Web server 2 runs on a machine which is completely separate from mail server 1 and SMS servers 9, and is designed to contain no critical business data to prevent inadvertent alteration of critical data or corruption by hackers. The configuration of web server 2 is similar to that of mail server 1. The business and program logic in mail server 1 is provided by a suite of Java applications. These applications handle database checking, mail routing (invalid, unreachable, banned, etc.) and SMS generation. The server applications communicate with database 16 via ODBC drivers, and with the SMS servers 9 via a Java Bean interface. Web server 2 is preferably physically located near mail server 1 for convenience, but this is not mandatory. A possible future scenario is for mail servers 1 to be located in each geographical market location with one web server 2 located centrally.

The distributed environment allows easy scaling of the infrastructure of the redirection service. When peak email traffic approaches capability limits of mail server 1, load sharing can quickly be implemented using a product such as Cisco Director, which efficiently distributes Internet services among Internet server sites while SMS gateway 12 scales simply by adding additional server boxes 9. Web server 2 is limited by its transactional processing capabilities and can be replaced by a more powerful server in the future.

Security is a significant concern when managing email on behalf of subscribers. The distributed environment and “sand boxing” of databases provides some protection against direct hacking. The SMS server and development environments additionally sit behind firewalls 17 in a similar manner to the firewall protection which guards internal administration network 8. In addition to the architecture design, other proactive business processes can be used to manage the environment to high security, both at the redirection service provider's end and at the recipient's end.

To minimize spamming of unregistered users, real time analyses of traffic and IP patterns can be used together with constantly updated banned lists. Mail filtering processes and software also enable registered users to minimize spam on inbound mail.

The first and second aspects of the invention provide a number of benefits to existing and new users of email, as well as to advertisers, Internet service providers and email service providers:

1. The service, in its preferred form, is free to consumers, so there are no economic barriers to adoption.

2. The service provides a valuable demographic audience for advertisers, to which offers can be targeted by geography (country code numbers and postcodes), telephone network provider, and email usage volume.

3. The service is particularly useful for people with hard-to-spell names or hard-to-remember email addresses, especially those people who are not established Internet users and find domain name structures confusing.

4. Many organizations hold telephone number details for their customers, members or other contacts, but do not hold email addresses. The invention allows them to communicate via email with the people for whom they hold telephone numbers, thus adding considerable value to the customer database.

5. Many people store the phone numbers of frequent contacts on their telephones. The invention immediately converts this database of telephone numbers into a database of email addresses.

6. When the invention is used in conjunction with mobile telephone numbers, the sender does not need to know which cellular network provider the recipient uses in order to send an email. Email can be sent using any mobile phone number on any network.

7. The mobile phone number becomes an unchanging email address, allowing the recipient to have hassle-free email control when changing ISP or job.

8. The invention stimulates take-up of Internet services and email services by making them more accessible to people who are less technically minded.

The third and fourth aspects of the invention, in which a telephone number can operate automatically as a website address, provide a number of benefits including the following:

1. It enables the user's mobile phone number to become the unique identifier for all media: voice, email and Internet address.

2. It stimulates take-up of Internet and hosting services by making the site more accessible to the phone owner's audience.

3. It reinforces and contributes to the usage of the redirection service's email service.

4. It provides a viable alternative web address in the event that a domain name is already taken.

5. It provides an additional level of surety in identifying a website as being legitimately associated with the business it claims to be associated with.

It is to be understood that various alterations additions and/or modifications may be made to the parts previously described without departing from the ambit of the invention.

1. A method of delivering email from a sender to a recipient, via a redirection service, including the following steps:
(a) the sender obtains the recipient's telephone number;
(b) the sender forwards an email message to the email address:
<telephone number>@<redirection service domain>
(c) the redirection service receives the message and checks to see whether the recipient's telephone number is registered with the redirection service;
(d) if the recipient's telephone number is registered, the redirection service forwards the email message to an address which has previously been specified by the recipient.

2. A method according to claim 1 including the additional step:
(e) if the recipient's telephone number is not registered, the redirection service forwards to the recipient a notification that email is waiting for the recipient.

3. A method according to claim 2 wherein the telephone number is a mobile telephone number, and the notification forwarded to unregistered recipients is an SMS (short message service) message.

4. A method according to claim 2 wherein the redirection service adds advertising material to redirected email messages, and the redirection service derives revenue from advertisers.

5. A method of directing a computer user to an Internet site associated with a person or business, via a redirection service, including the following steps:
(a) the computer user obtains the telephone number of the person or business;
(b) the computer user types into an Internet browser the following:
<telephone number>@<redirection service domain>
(c) the redirection service checks to see whether the person or business's telephone number is registered with the redirection service;
(d) if the person or business's telephone number is registered, the redirection service redirects the computer user's browser to an Internet address which has previously been specified by the person or business.

6. A method according to claim 5 including the additional step:
(e) if the person or business's telephone number is not registered, the redirection service forwards to the person or business a notification inviting the person or business to register.

7. A method according to claim 6 wherein the telephone number is a mobile telephone number, and the notification forwarded to unregistered persons and businesses is an SMS (short message service) message.

8. A method according to claim 5 wherein, unless otherwise arranged by the person or business whose telephone number is registered, the redirection service displays advertising material for a short time before proceeding with the redirection, and the redirection service derives revenue from advertisers.

9. A method according to claim 8 wherein the person or business whose telephone number is registered may elect to pay a fee to the redirection service, whereupon redirection proceeds immediately, with no advertising material being displayed.

10. A method of delivering email from a sender to a recipient, via a redirection service, including the following steps:
(a) the sender has redirection service software integrated into or additional to his or her email software;
(b) the sender obtains the recipient's telephone number;
(c) the sender sends an email message to the email address:
<telephone number>
using the redirection service software and/or his or her standard email application software;
(d) the redirection service software forwards the recipient's telephone number to the redirection service;
(e) the redirection service receives the telephone number and checks to see whether it is registered with the redirection service;
(f) if the recipient's telephone number is registered, the redirection service forwards the email message to an address which has previously been specified by the recipient.

11. A method according to claim 10 wherein the email address used by the sender includes an identifier in addition to the recipient's telephone number, and the purpose of the identifier is to alert the redirection service software that the email address being entered is a telephone number rather than a normal email address.

12. A method according to claim 10 including the additional step:
(g) if the recipient's telephone number is not registered, the redirection service forwards to the recipient a notification that email is waiting for the recipient.

13. A method according to claim 12 wherein the telephone number is a mobile telephone number, and the notification forwarded to unregistered recipients is an SMS (short message service) message.

14. A method of directing a computer user to an Internet site associated with a person or business, via a redirection service, including the following steps:
(a) the computer user has redirection service software integrated into or additional to his or her web browser software;
(b) the computer user obtains the telephone number of the person or business;
(c) the computer user types into an Internet browser or the redirection service software the following:
<telephone number>
(d) the redirection service software forwards the telephone number to the redirection service;
(c) the redirection service checks to see whether the person or business's telephone number is registered with the redirection service;
(e) if the person or business's telephone number is registered, the redirection service redirects the computer user's browser to an Internet address which has previously been specified by the person or business.

15. A method according to claim 14 wherein the Internet address which the computer user types into his or her browser includes an identifier in addition to the person or business's telephone number, and the purpose of the identifier is to alert the redirection service software that the Internet address being entered is a telephone number rather than a normal Internet address.

16. A method according to claim 14 including the additional step:
(f) if the person or business's telephone number is not registered, the redirection service forwards to the person or business a notification inviting the person or business to register.

17. A method according to claim 6 wherein the telephone number is a mobile telephone number, and the notification forwarded to unregistered persons and businesses is an SMS (short message service) message.
